(19) United States
(12) Patent Application Publication
(10) Pub. No.: US 2016/0038955 A1
(43) Pub. Date: Feb. 11, 2016

(54) Shower spa attachment

(71) Applicants: Daniel R. Cohen, Manalapan, NJ (US); Noel L. Newman, Jackson, NJ (US)

(72) Inventors: Daniel R. Cohen, Manalapan, NJ (US); Noel L. Newman, Jackson, NJ (US)

(21) Appl. No.: 14/121,197

(22) Filed: Aug. 11, 2014

(51) Int. Cl. B05B 1/18

(52) U.S. Cl. CPC B05B 1/185

(57) ABSTRACT

A shower spa attachment has a number of variable spray configuration shower heads connected together which can be connected directly to the existing water pipe or via a diverter valve to the existing shower head. The shower spa attachment can be fitted directly to the pipe and used without the diverter or existing top shower head or connected to the diverter valve and used in conjunction with the top shower head. Each of the variable spray heads may be removably attached to the shower wall in any desired configuration via flexible hose interconnection. Alternatively, the spray heads may be mounted on a hanging panel.

### CROSS-REFERENCE TO RELATED APPLICATION

Applicants claim priority of U.S. Provisional Application Ser. No. 61/959,171 filed Aug. 16, 2013.

### SUMMARY OF THE INVENTION AND DESCRIPTION OF RELATED ART

The present invention relates to a shower spa attachment which has a number of variable spray configuration shower heads connected together which can be connected directly to the existing water pipe or via a diverter valve to the existing shower head. The shower spa attachment can be fitted directly to the pipe and used without the diverter or existing top shower head or connected to the diverter valve and used in conjunction with the top shower head. Each of the variable spray heads are removably attached to the shower wall in any desired configuration.

We have invented an attachment to existing bath showers which convert the single head shower to a multi-head shower experience. Each of the shower heads of our invention is removably located on the shower wall to enable the user to create a desired experience.

The prior art offers shower spas; however, these are custom built into the shower at substantial cost and require professional installation. The installation necessitates construction, plumbing, the resultant loss of access to the bathroom and required clean-up.

The present invention is a shower spa with one or more jet sprays that is easily installed by anyone without a plumber, without drilling into the wall and is low in cost. The invention may be connected directly to the shower pipe so that only the jet sprays are used. If used with a two way diverter valve, after installation, the regular shower with just the top shower head can be used, or the shower spa mode is utilized with the jet sprays. If used with a three way diverter valve, the ability to use both the top shower head and the jet sprays together is also provided. Each spray jet may have single or multiple spray functions such as a mist spray, a pulsating massage spray, and a combination spray.

If the flow of water to the shower head and the jet sprays is controlled by the two or three way diverter valve, the existing shower head is removed and the diverter valve installed. The existing head is re-placed to a connection on the diverter valve. The jet sprays are attached to the diverter by a connection on the flexible hose holding the jet spray nozzles. Alternatively, a hand held shower attachment is used in lieu of a top shower head and it can be attached to the bracket on the three way diverter valve. The jet sprays are attached to the diverter by a connection on the flexible hose holding the jet spray nozzles. If no diverter valve is used, the jet sprays are used without top shower head. A pair of two way diverter valves may be used in lieu of a three way diverter valve to produce the same capabilities as a three way diverter valve.

Thus the invention may be used as follows:

No Diverter Valve—Attach shower spa directly to pipe and only use jet spray nozzles;

Two-way diverter valve—Use top shower head by itself, or jet spray nozzles by themselves;

Three-Way diverter valve—Same as two way valve plus the top shower head and jet sprays may be used together.

The jet spray(s) are attached to flexible shower hose. The first length of hose uses a connecter to connect the hose to the diverter valve (or alternatively the water pipe directly). The hose is then connected to a hose barb which is attached to the jet sprays. With the flexible hose, one can place each jet spray as desired on the wall When used with three jet sprays, some examples of placement are: in an “S” design so the jet sprays go in a line top to bottom; a “U” shaped design; an “N” shaped design, etc. For smaller showers, they can be placed on a side wall. A jet spray can be directed at any part of the body. With the flexible hose, the spray jets can be positioned around the hot/cold water valve, soap dish, or any other item on the shower wall. Each jet head may also swivel.

The spray jets are removably attached to the shower wall by suction cups, adhesive, double-sided tape, VELCRO®, removable adhesive or sticky materials, or any other material which allows the spray jets to be repositioned on the wall. This permits the user to create an infinite variety of patterns as desired by placement of the spray jets.

The prior art includes, Davison, U.S. Pat. No. 5,909,969 and the references cited therein which disclose full body shower systems and attachments but do not offer the ability to locate the shower sprays as desired. In addition, shower panel systems sold under the name DremLine and other names, require construction and plumbing to install, but do not offer the ability to locate the shower sprays as desired.

An alternate embodiment of our invention is a panel unit which fixes the spray jets on the panel, with different placement or configuration of the jet sprays on different models. This alternate embodiment may be fitted directly to the water pipe or, with a diverter valve, converts the single head shower to a multi-head shower experience. The alternate embodiment is a panel shower spa with one or more jet sprays that is easily installed by anyone without a plumber, without drilling into the wall and is low in cost.

The prior art offers shower spas; however, these are custom built into the shower at substantial cost and require professional installation. The installation necessitates construction, plumbing, and the resultant loss of access to the bathroom and required clean-up.

### BRIEF DESCRIPTION OF THE DRAWINGS

FIG. 1 is a perspective view of a spray jet head;

FIG. 2 is a perspective view of the spray jet head of FIG. 1 with the mounting flange removed;

FIG. 3 is a is a perspective view of the spray jet head of FIG. 1 partially disassembled;

FIG. 4 is a front view of the mounting flange;

FIG. 5 is a is a back view of the mounting flange;

FIG. 6 is a side view of the mounting flange;

FIG. 7 is a perspective view of the suction cup mounting parts of the spray jet head of FIG. 1;

FIG. 8 is a perspective view of the parts of FIG. 7 assembled for use;

FIG. 8A and 8B are side views of the mounting of FIGS. 7 and 8;

FIG. 8C is a perspective view of the parts of FIGS. 7-8B attached to the mounting flange;

FIG. 9 is a back view of the assembly of FIG. 7;

FIG. 10 is a perspective view of the rear of the spray jet head with mounting flange attached;

FIG. 11 is a back view of the spray head with water hoses attached;

FIG. 12 is a top perspective view of the spray head of FIG. 11;

FIG. 13 is a perspective view of the spray jet head assembly with a threaded attachment flange;

FIG. 14 is a side view of the spray jet head assembly of FIG. 13;

FIG. 14A is side view of the assembly of FIGS. 13-14 with hose attachment holes;

FIG. 15 is a perspective view of a three-way diverter valve;

FIG. 16 is a perspective view of a two-way diverter valve;

FIG. 17 is a perspective view of the three-way diverter valve of FIG. 15 attached to a shower head;

FIG. 18 is a side view of the water hose used between spray heads;

FIG. 19 is a plan view of the assembled shower spa system;

FIG. 20 is a perspective view of the shower spa attachment attached to a shower wall;

FIG. 21 is a is a perspective view of the shower spa attachment of FIG. 20 configured in a different shape;

FIG. 22 is a perspective view of a shower spa attachment with four spray heads;

FIGS. 23-24 are perspective views of alternate suction cup attachment structures;

FIGS. 25-28 are perspective views of another embodiment of the invention employing a panel mount; and

FIG. 29 is a perspective view of an alternate push button suction cup.

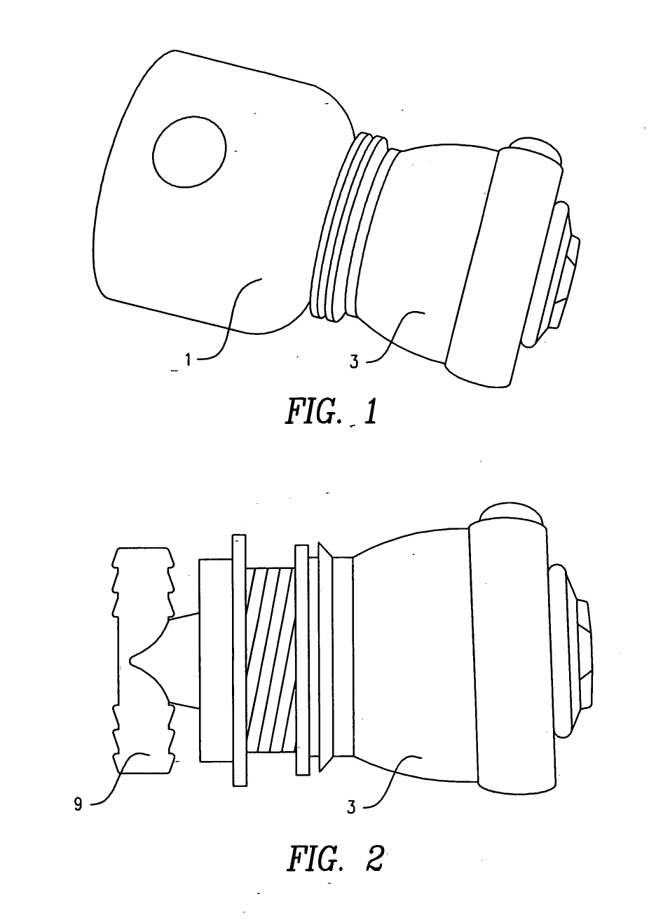

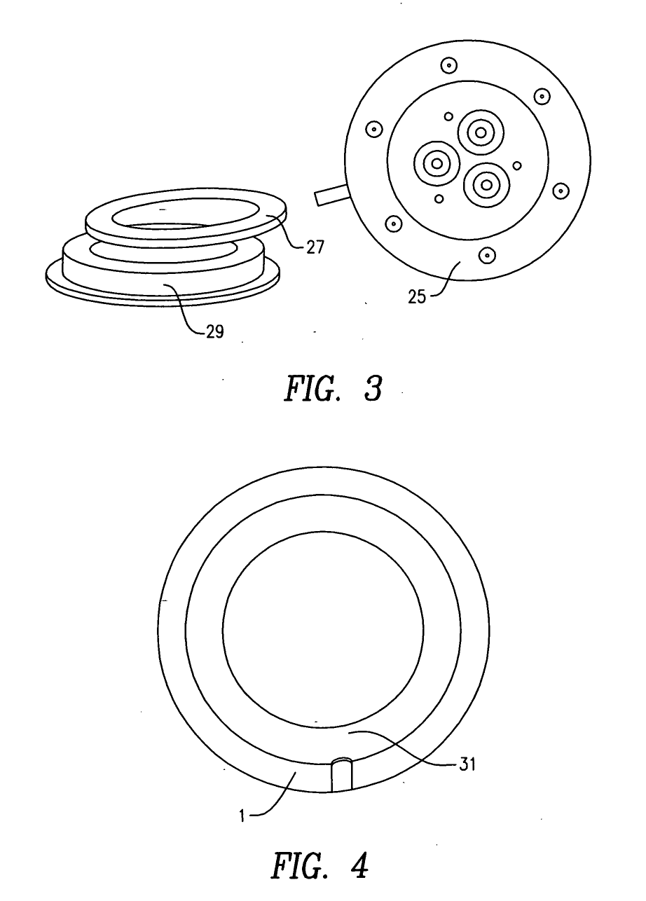

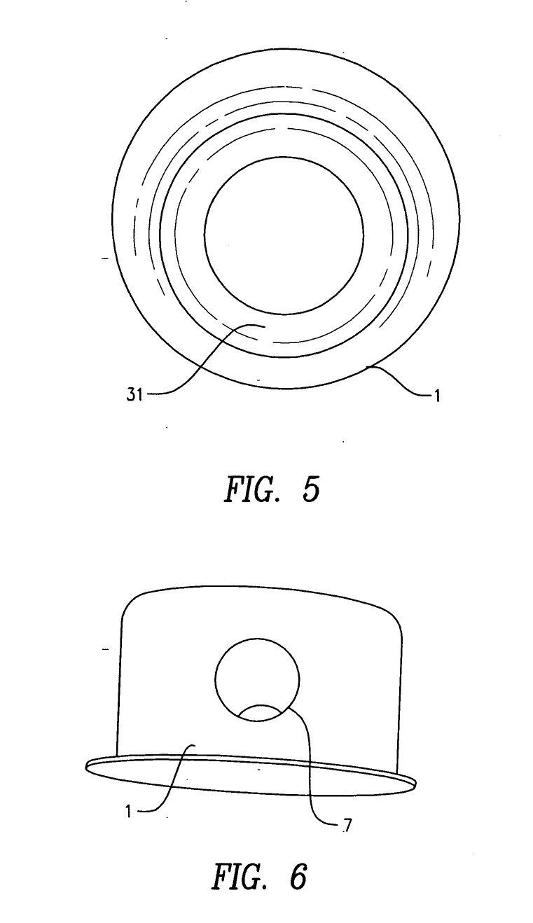

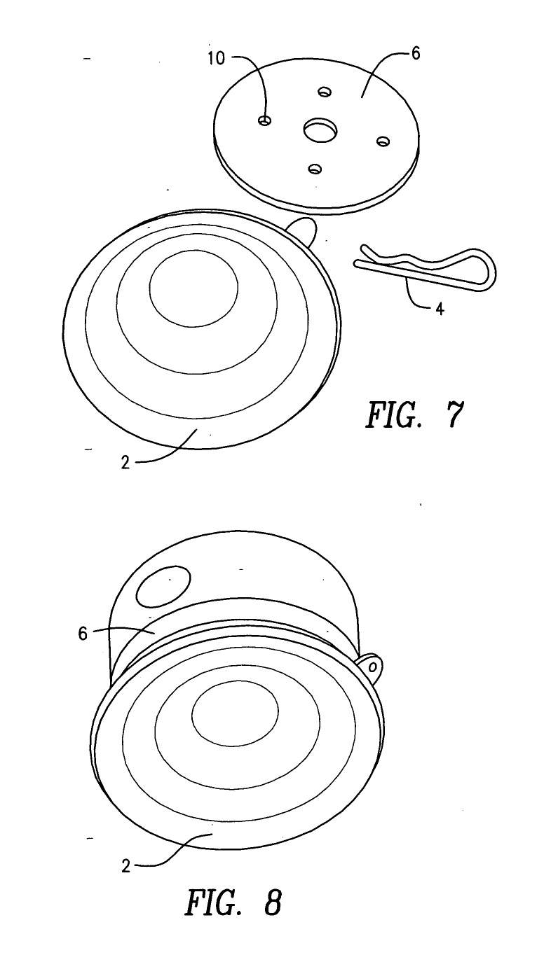

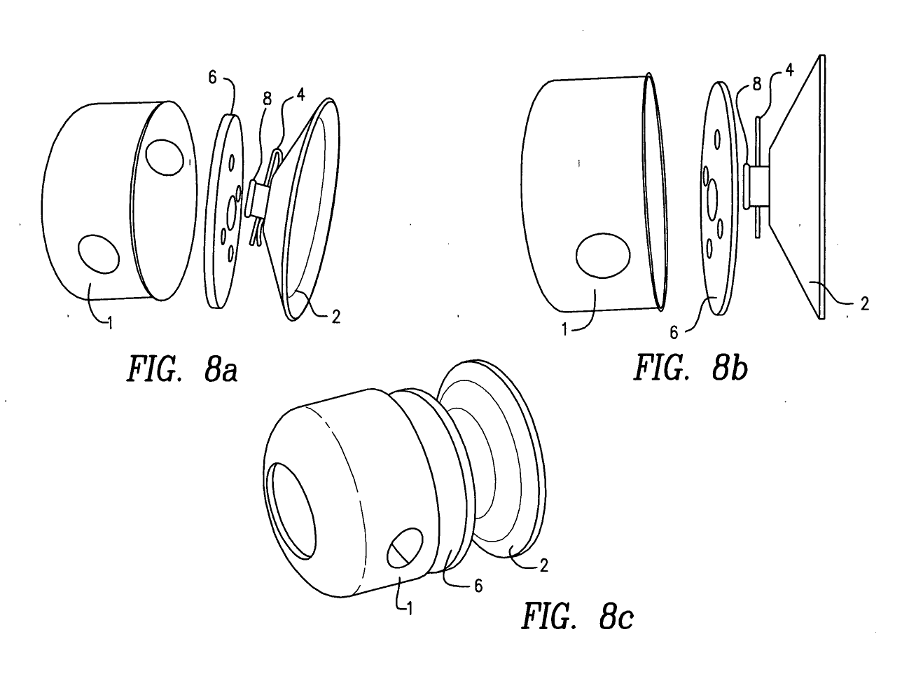

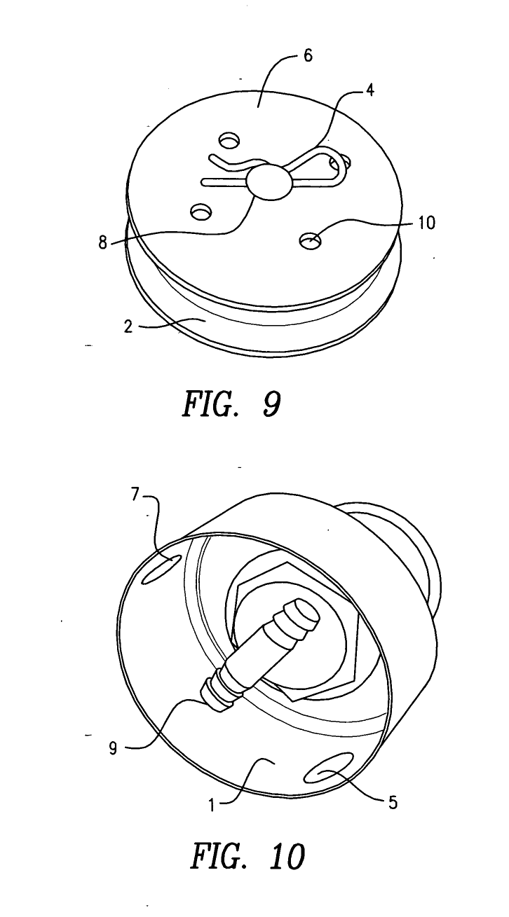

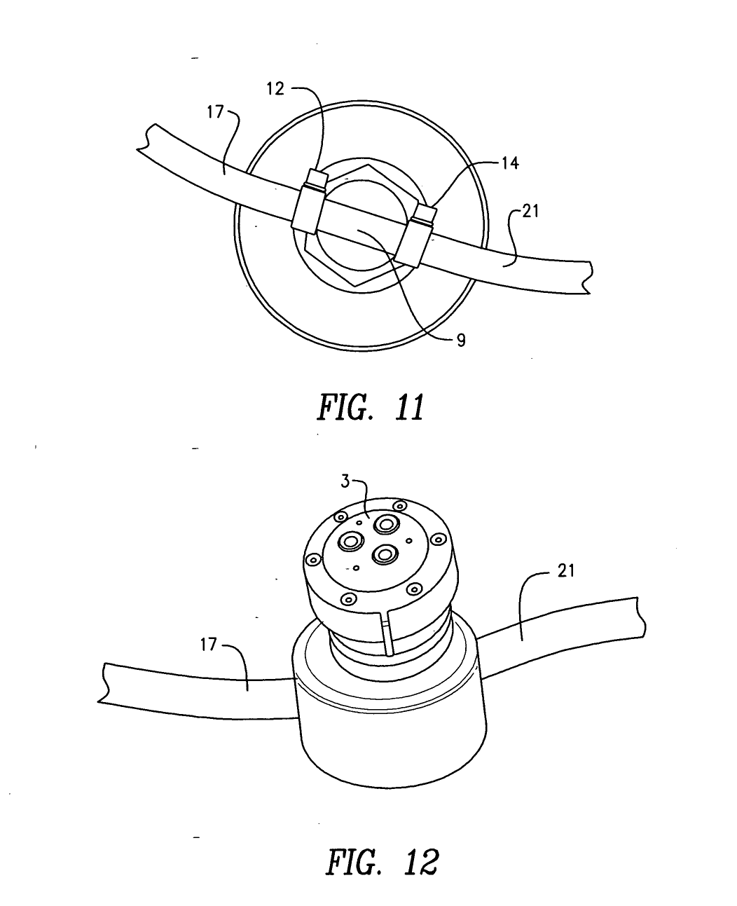

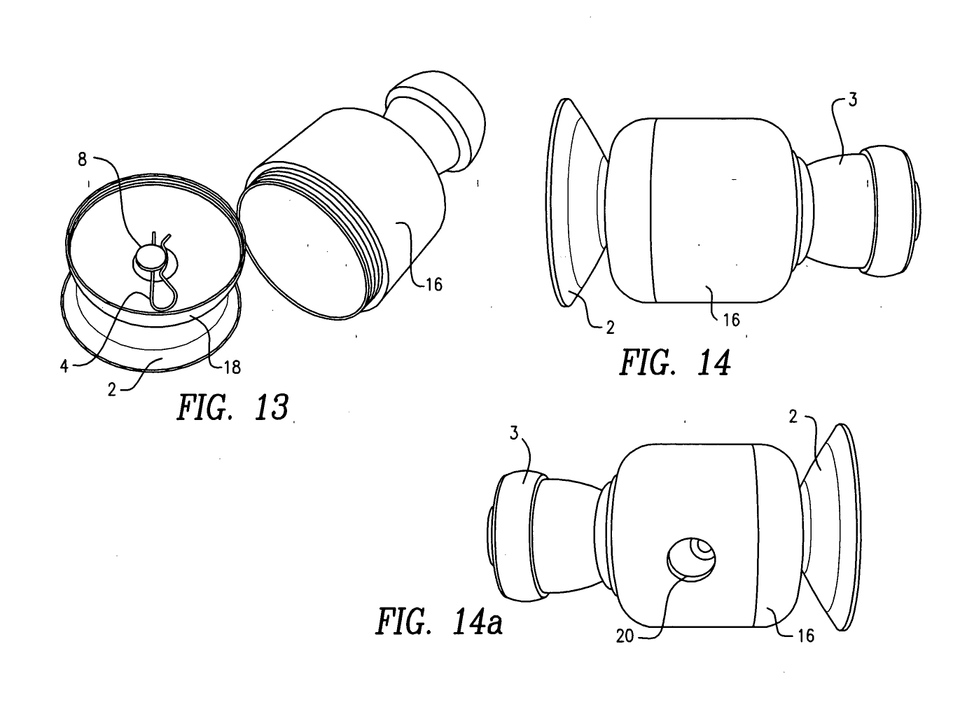

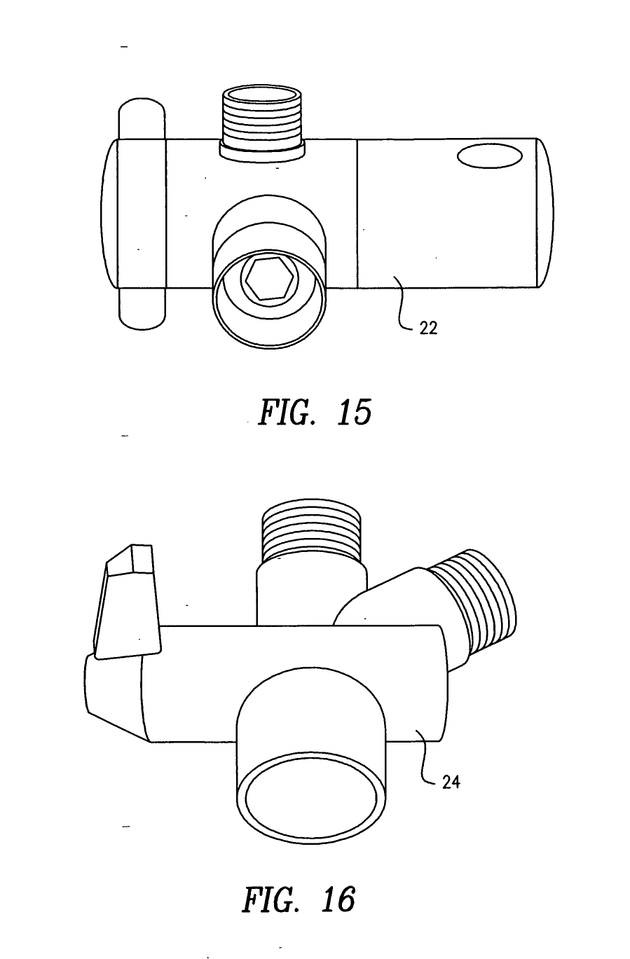

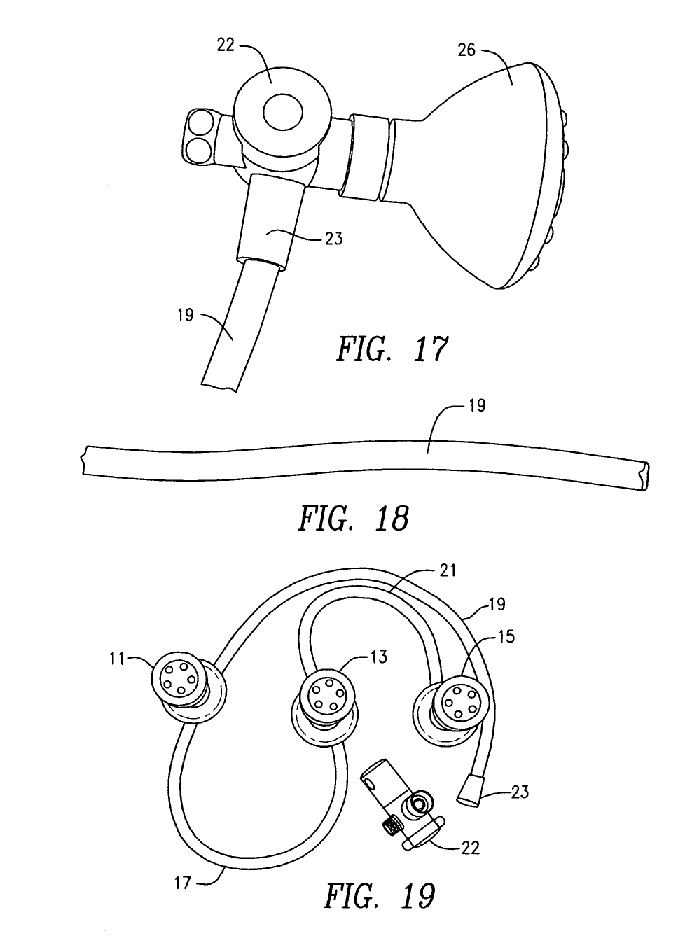

### DETAILED DESCRIPTION OF THE INVENTION

The following table sets forth the correspondence between the reference numerals used in and the parts denoted in the drawings.
1 flange
2 suction cup
3 spray jet head
4 spring pin
5, 7 holes in flange
6 disc
8 cylindrical protrusion on bottom of suction cup
9 barbed hose connector
10 drain holes in disc 6
12, 14 hose clamps
11, 13, 15, spray jet heads in a three head configuration
16 threaded flange
18 threaded disc
17, 19, 21 water hoses
20 hose connection hole in flange 16
22 three way diverter valve
23 connector to two or three way diverter valve
24 two way diverter valve
25 front of spray jet head
26 existing shower head
27 washer
28 threaded post
29 threaded seal
30 nut
31 top rim of flange 1
32 flexible protrusion
33 panel
34 spray head
35 central spray head
36 U shaped hanger
37 spacer
38 water hose connection
39 water hose
40 lateral water hose
41 push button suction cup
42 hook
43 hole

The spray jet head 3 is commercially available from CIXI SHOWER-RAIN SANITARY WARE CO. LTD, Cangtian Industrial Zone, Changhe Town, CIXI City, Zhejiang, PR CHINA.

The suction cup 2 is also commercially available from Adams Mfg. Corp., 109 West Park Road, Portersville Pa. 16051.

The two and three way diverter valves and hoses are commercially available from LDR Industries, 600 N. Kilbourn Ave., Chicago, Ill. 60624.

As will be seen from a review of the drawings, the spray jet head 3 is interfit within flanges 1 or 16. Flange 1 has disc 6 with a central hole for receiving cylindrical portion 8 of the suction cup 2. Pin 4 attaches the suction cup to the cylindrical protrusion via a hole formed in the protrusion. Flange 16 has disc 18 which similarly attaches to the suction cup cylindrical portion. Flanges 1 and 16 differ only in the use of internal screw threads in flange 16.

Flange 1 and disc 6 are compression fit while flange 16 and disc 18 have screw threads formed thereon for a threaded engagement.

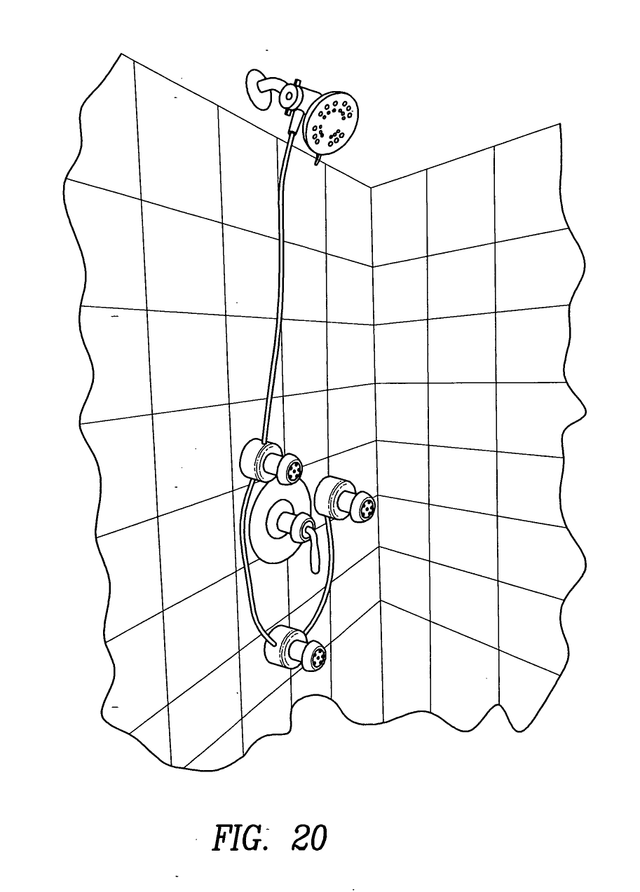

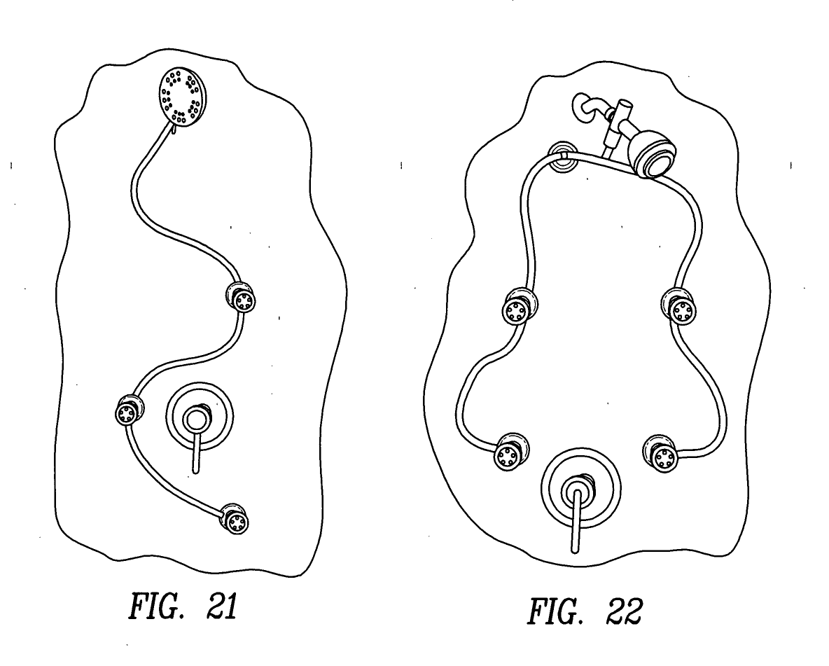

Depending upon the user's shower water pressure, three or four headed systems may be used which as shown in FIGS. 19-22 may be configured by the user as desired.

The connection hoses 17, 19, and 21 are firmly attached to the barbed hose connector 9 in spray jet head 3 with hose clamps 12, 14. Holes 5, 7 are required in the flanges 1 and 16 to permit the connection hoses 17, etc. to reach the barbed connector 9. Drain holes 10 may be provided in discs 6 and 18 to permit water to exit the flanges 1 or 16.

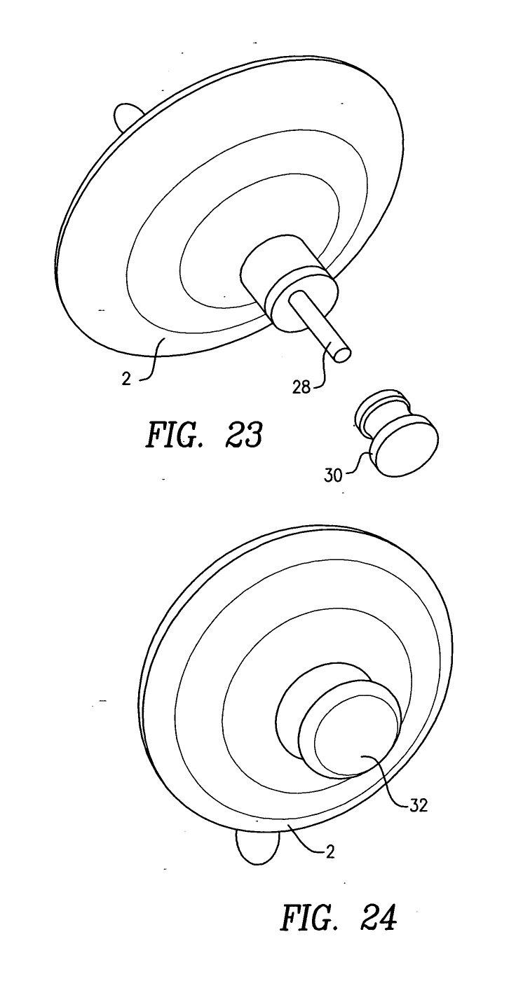

As shown in FIGS. 23-24, alternate suction cup attachment structure may be used. In FIG. 23, a threaded post 28 and nut 30 are used to fasten the suction cup 2 to either of the discs 6 or 18 using the central hole in the discs. In FIG. 24, suction cup 2 has a flexible protrusion 32 which is forced into the central hole in either disc 6 or 18.

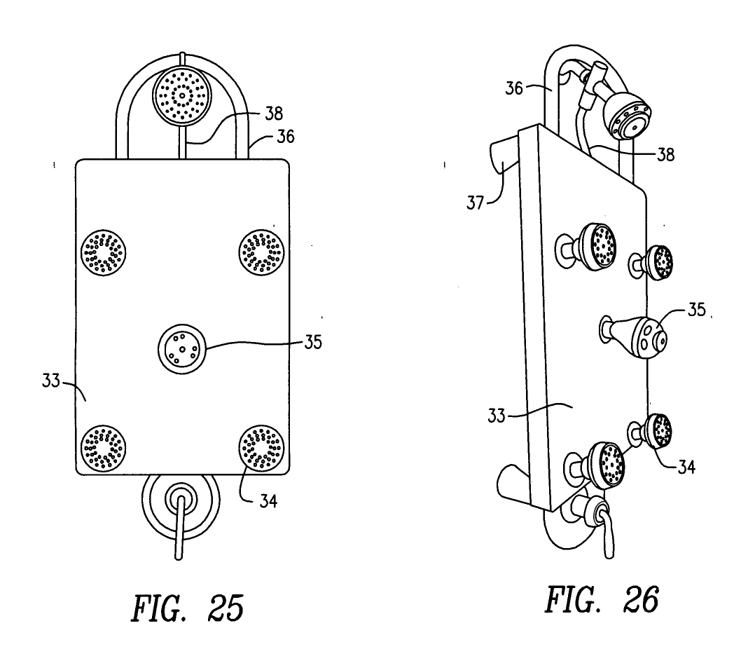

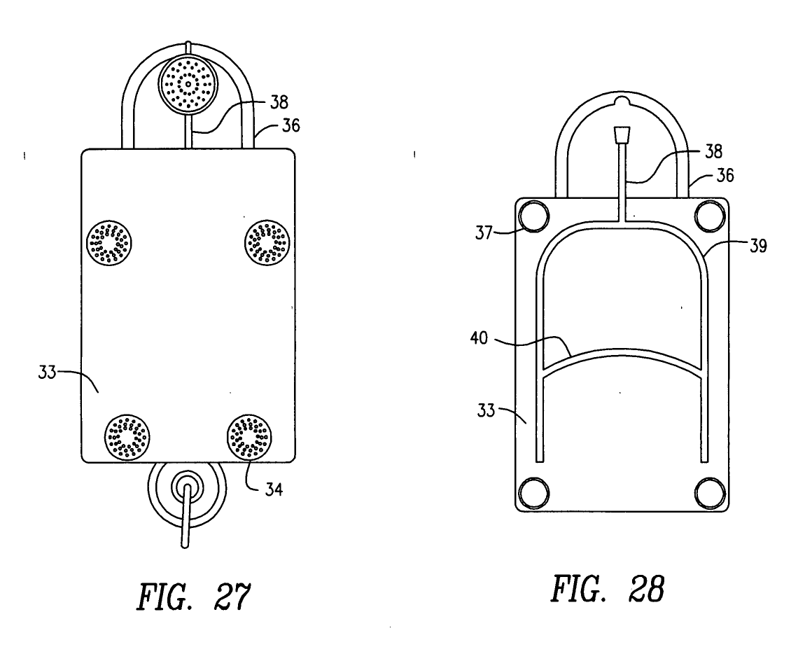

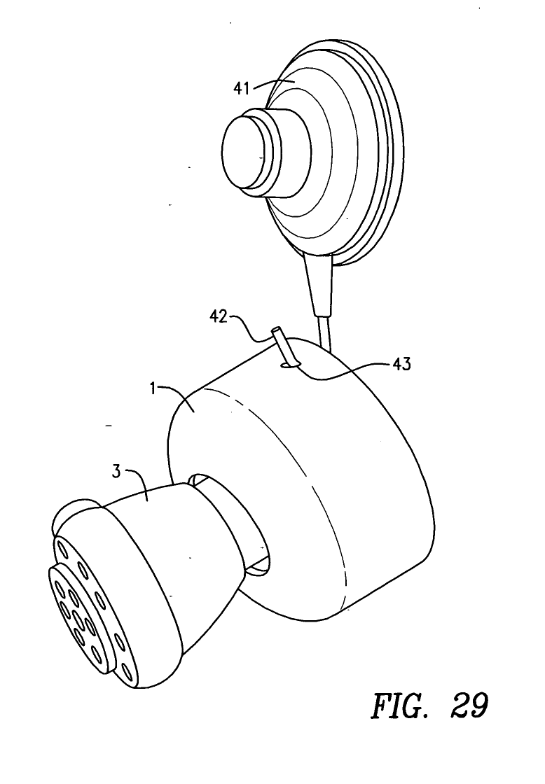

FIGS. 25-28 show an alternate embodiment of the invention where the spray heads are mounted on a hanging panel 33. A U-shaped hanger 36 is attached to the top of panel 33. The hanger sits on the top of the existing shower head water pipe. Four spray heads 34 and a central spray head 35 are affixed to the panel in FIGS. 25-26. The central head 35 is eliminated in the embodiment shown in FIGS. 27-28. Spacers 37 which may be of conical shape serve to support the panel by holding it off the shower wall. Water hose 38 connects the existing water supply to the spray heads via water hose 39 and lateral water hose 40.

In FIG. 29, a push button release suction cup 41 has a hook 42 incorporated therein. The spray head 3 is hung from the hook 42 using a hole 43 in flange 1.

Further modifications to the methods and apparatus of the invention may be made without departing from the spirit and scope of the invention.

1. A shower spa attachment comprising: two or more shower spray jet heads; a flexible water hose connected to each of said spray heads; fastening means connected to each of said shower spray jet heads for removably fastening said heads to a shower wall whereby said shower spray jet heads may be configured in any desired position on the shower wall; and a fitting connected to said water hose for directly connecting said hose to an existing source of pressurized water.

2. (canceled)

3. The shower spa attachment of claim 1 further including a diverter valve connected between said source of pressurized water and said fitting.

4. The shower spa attachment of claim 3 wherein said diverter valve is selected from the group consisting of: a three-way diverter valve, or a pair of two-way diverter valves.

5. (canceled)

6. The shower spa attachment of claim 1 wherein said fastening means is selected from the group consisting of suction cup; adhesive, double-sided tape, VELCRO®, removable adhesive or sticky materials.

7. The attachment of claim 6 wherein said suction cup includes a hook means for suspending a spray head therefrom.

8. (canceled)

9. (canceled)

10. (canceled)

11. (canceled)

12. An attachment for a shower comprising: one or more shower spray jet heads mounted on a panel, a water hose connected to each of said spray heads, and a fitting connected to said water hose for connecting said hose to an existing source of pressurized water.

13. The attachment of claim 12 wherein said fitting is connected directly to said source of pressurized water.

14. The attachment of claim 12 further including a diverter valve connected between said source of pressurized water and said fitting.

15. The attachment of claim 14 wherein said diverter valve is selected from the group consisting of: a two-way diverter valve; a three-way diverter valve, or a pair of two-way diverter valves.

16. The attachment of claim 12 further including hanger means connected to said panel for suspending said panel on said source of pressurized water.

17. The attachment of claim 12 further including spacer means mounted on said panel for securing and supporting said panel on a shower wall.

18. A shower spa attachment comprising: two or more shower spray jet heads; a flexible water hose connected to each of said spray heads; suction cup fastening means connected to each of said shower spray jet heads for removably fastening said heads to a shower wall whereby said shower spray jet heads may be configured in any desired position on the shower wall; a fitting connected to said water hose for directly connecting said hose to an existing source of pressurized water, a diverter valve connected between said source of pressurized water and said fitting; connection means for securing said suction cup to said spray head, said connection means including a disc having a central aperture formed therein, said suction cup having a threaded post formed thereon for interfitting into said aperture and a nut to secure said suction cup to said disc, and a housing for each of said spray heads, said disc being connected to said housing.

19. A shower spa attachment comprising: two or more shower spray jet heads; a flexible water hose connected to each of said spray heads; suction cup fastening means connected to each of said shower spray jet heads for removably fastening said heads to a shower wall whereby said shower spray jet heads may be configured in any desired position on the shower wall; a fitting connected to said water hose for directly connecting said hose to an existing source of pressurized water, a diverter valve connected between said source of pressurized water and said fitting; connection means for securing said suction cup to said spray head, said connection means including a disc having a central aperture formed therein, said suction cup having a flexible protrusion formed thereon forced into said aperture to secure said suction cup to said disc, and a housing for each of said spray heads, said disc being connected to said housing.
